(19) United States
(12) Patent Application Publication
(10) Pub. No.: US 2016/0360695 A1
(43) Pub. Date: Dec. 15, 2016

(54) CUTTING BLADE

(71) Applicant: HUSQVARNA AB, Huskvarna (SE)

(72) Inventor: Fredrik Klackensjö, Forserum (SE)

(73) Assignee: HUSQVARNA AB, Huskvarna (SE)

(21) Appl. No.: 15/121,474

(22) PCT Filed: Feb. 26, 2014
(86) PCT No.: PCT/SE2014/050237

§ 371 Date: Aug. 25, 2016

(51) Int. Cl. A01D 34/73; A01D 34/00

(52) U.S. Cl. CPC A01D 34/73; A01D 34/008; A01D 2101/00

(57) ABSTRACT

The invention relates to a cutting blade (110, 500, 600, 700) for a robotic mower (100). The cutting blade includes a first end section (302) and a second end section (304), and two lateral sections (306, 308, 502, 602, 604, 702, 704) extending between the first and second end sections. Further, at least one of the two lateral sections includes at least one cutting portion (310A, 310B, 612, 712A, 712B) configured to cut vegetation and at least one protective portion (312A, 312B, 614, 714A, 714B) configured to protect the at least one cutting portion.

### TECHNICAL FIELD

The present invention relates to a cutting blade for a mower. More particularly, the present invention relates to a cutting blade for a robotic mower.

### BACKGROUND

Robotic mowers, used for garden or lawn maintenance, are well known in the art. Typically, a robotic mower includes multiple cutting blades detachably connected to a blade holder. The blade holder is arranged to rotate about a vertical axis and is powered by a prime mower of the robotic mower to rotate the cutting blades.

Generally, during a cutting operation, a cutting edge of the cutting blades may strike any object other than vegetation, such as, sticks, stones, toys etc. Thus, the cutting edge may become blunt and consequently, the cutting blades need to be replaced frequently.

In light of the foregoing, there is a need for a cutting blade which has an increased operating life.

### SUMMARY

In view of the above, it is an objective to solve or at least reduce the problems discussed above. In particular, an objective is to provide an improved cutting blade for a robotic mower.

The objective is achieved with a novel cutting blade according to claim 1. The cutting blade for a robotic mower includes a first end section and a second end section, and two lateral sections extending between the first and second end sections. Further, at least one of the two lateral sections includes at least one cutting portion configured to cut vegetation and at least one protective portion configured to protect the at least one cutting portion. Further, according to claim 2, the at least one protective portion is manufactured to cut vegetation and configured to strike against objects other than vegetation to protect the at least one cutting portion. During a cutting operation, the cutting blade may strike against objects, such as, sticks, stones, toys etc. In such case, only the at least one protective portion contacts objects and safeguards the at least one cutting portion. Thus, at least one cutting portions may continue to cut vegetation normally without getting blunt by repeated contacts against objects. Therefore, an operating life of the cutting blade is substantially increased. Thus, periods between replacements of the cutting blades are also increased.

According to claim 3, the at least one lateral section includes at least one inclined edge. At least a portion of the at least one inclined edge is inclined relative to a longitudinal axis of the cutting blade. Moreover, the at least one inclined edge includes the at least one cutting portion and the at least one protective portion. Further, according to claim 4, the at least one cutting portion is located adjacent a proximate end of the at least one inclined edge, and the at least one protective portion is located adjacent a distal end of the at least one inclined edge. Moreover, according to claim 5, the at least one lateral section includes at least one first inclined edge and at least one second inclined edge connected to each other at their distal ends. According to claim 6, the at least one lateral section includes multiple first inclined edges and second inclined edges arranged alternatively. Such a configuration ensures that only the protective portions contact objects during a cutting operation, thereby safeguarding the cutting portions.

According to claim 7, the at least one lateral section further includes an intermediate portion connecting the at least one inclined edge to the first end section. Further, according to claim 8, the intermediate portion is inclined relative to the longitudinal axis of the cutting blade.

According to claim 9, the at least one inclined edge is straight, curvilinear, or polygonal.

According to the claim 10, both the lateral sections include the at least one cutting portion and the at least one protective portion.

According to the claim 11, the cutting blade is symmetric about the longitudinal axis. Alternatively, according to claim 12, the cutting blade is asymmetric about the longitudinal axis.

According to claim 13, the cutting blade further includes a gripping member enclosing at least partly the two lateral sections. Further, according to claim 14, the gripping member is made of rubber.

According to claim 15, wherein at least one cutting blade is detachably attached to a blade holder of the robotic mower proximate the first end section, the blade holder being configured to be rotatably driven. Further, according to claim 16, the cutting blade further comprises an aperture proximate the first end section, the cutting blade being detachably attached to the blade holder via a fastening member passing through the aperture.

### BRIEF DESCRIPTION OF THE DRAWINGS

The invention will be described in more detail with reference to the enclosed drawings, wherein:

FIG. 1 illustrates a bottom view of a robotic mower, according to an embodiment of the present invention;

FIG. 2 illustrates an exploded view of a cutting unit, according to an embodiment of the present invention;

FIG. 3 illustrates a top view of a cutting blade, according to an embodiment of the present invention; FIG. 4 illustrates a detailed view of inclined edges of the cutting blade, according to the embodiment of FIG. 3;

FIG. 5 illustrates a top view of the cutting blade with a gripping member, according to an embodiment of present invention;

FIG. 6 illustrates a top view of the cutting blade, according to another embodiment of present invention;

FIG. 7 illustrates a top view of the cutting blade, according to yet another embodiment of present invention; and

FIG. 8 illustrates a top view of the cutting blade, according to a further embodiment of present invention.

### DESCRIPTION OF EMBODIMENTS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those ordinarily skilled in the art. For example, one or more aspects of the present invention can be utilized in other embodiments and even other types of devices. In the drawings, like numbers refer to like elements.

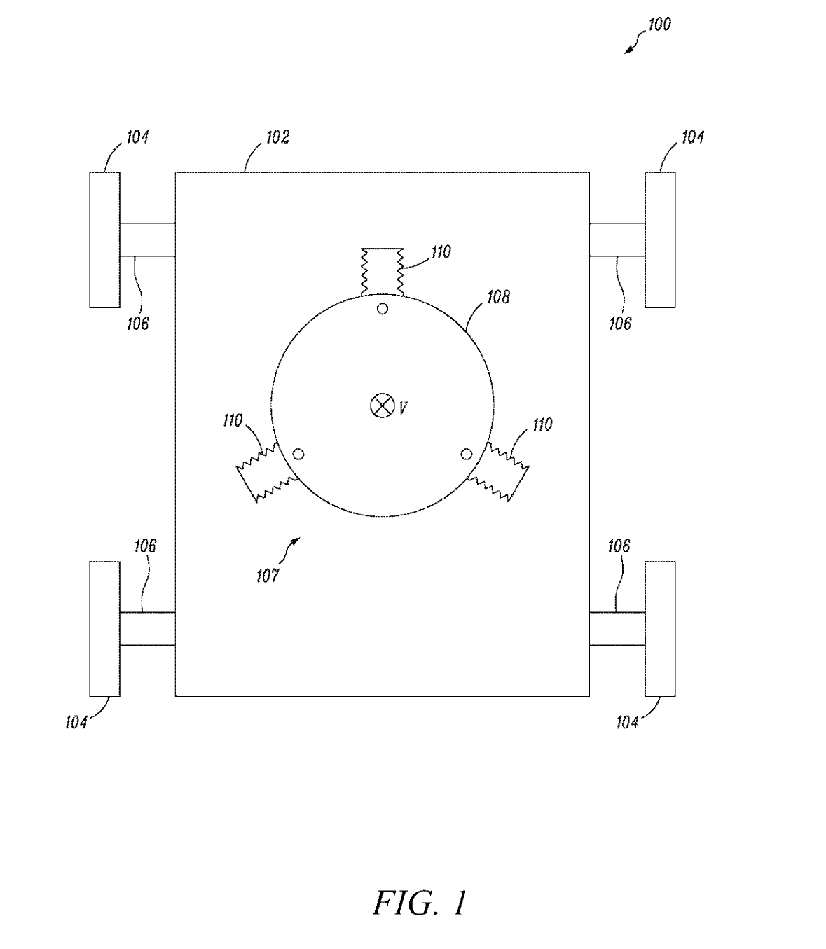

FIG. 1 illustrates a bottom view of a robotic mower 100, according to an embodiment of the present invention. The robotic mower 100 may be powered by a prime mover (not shown) for example, an electric motor, an engine, or the like.

As illustrated in FIG. 1, the robotic mower 100 includes a body 102 and ground engaging wheels 104 attached to the body 102 via axles 106. In various embodiments of the present invention, two or more wheels 104 may be driven. The robotic mower 100 may be steered by varying the power provided to each of the driven wheels. Further, at least two caster wheels may be provided instead of two of the wheels 104. In various embodiments, the robotic mower 100 may also include a battery for powering the prime mover, a control unit and a keypad. The robotic mower 100 may periodically charge the battery automatically at a charging station. The control unit may include programmable instructions for controlling all activities of the robotic mower 100, for example, but not limited to, cutting algorithm, periodic charging etc. The control unit may also wirelessly communicate with other devices (E.g., a PC or a mobile phone). A user may be provided with regular updates on the status of the robotic mower 100. The keypad may be used to enter various parameters. In an embodiment, a working area (E.g., a garden, lawn etc.) of the robotic mower 100 may be delimited by a boundary wire which emits a signal. The robotic mower 100 may include various sensors to detect the signal and the control unit regulates the robotic mower 100 accordingly. The robotic mower 100 may also include obstacle detection sensors.

As illustrated in FIG. 1, a cutting unit 107 is provided on bottom side of the body 102. The cutting unit 107 includes a blade holder 108 which is configured to rotate about an axis of rotation V. The blade holder 108 may be driven by the prime mover. In an embodiment, the blade holder 108 may be directly mounted on an output shaft of the prime mover. Alternatively, the blade holder 108 may be driven by the prime mover via a transmission assembly. The transmission assembly may include a clutch and brake. As illustrated in FIG. 1, the blade holder 108 is a rotating disc. However, the blade holder 108 may be any other shape within the scope of the present invention. Further, at least one cutting blade 110 is attached to the blade holder 108. Thus, during an operation of the robotic mower 100, the cutting blade 110 rotates along with the blade holder 108 to cut vegetation, such as, grass. In the exemplary embodiment, as illustrated in FIG. 1, the cutting unit 107 includes three cutting blades 110 which are connected to the blade holder 108. However, there may be any number of cutting blades 110 attached to the blade holder 108 within the scope of the present invention. Further, the cutting blades 110 may be attached to the blade holder 108 such that an angle of 120 degrees exists between each cutting blade 110. Such an arrangement balances the forces acting on the blade holder 110. In various embodiment of the present invention, a height of the blade holder 108 and/or each wheel 104 relative to the ground may be adjustable, thereby enabling modification in a cutting height of each cutting blade 110.

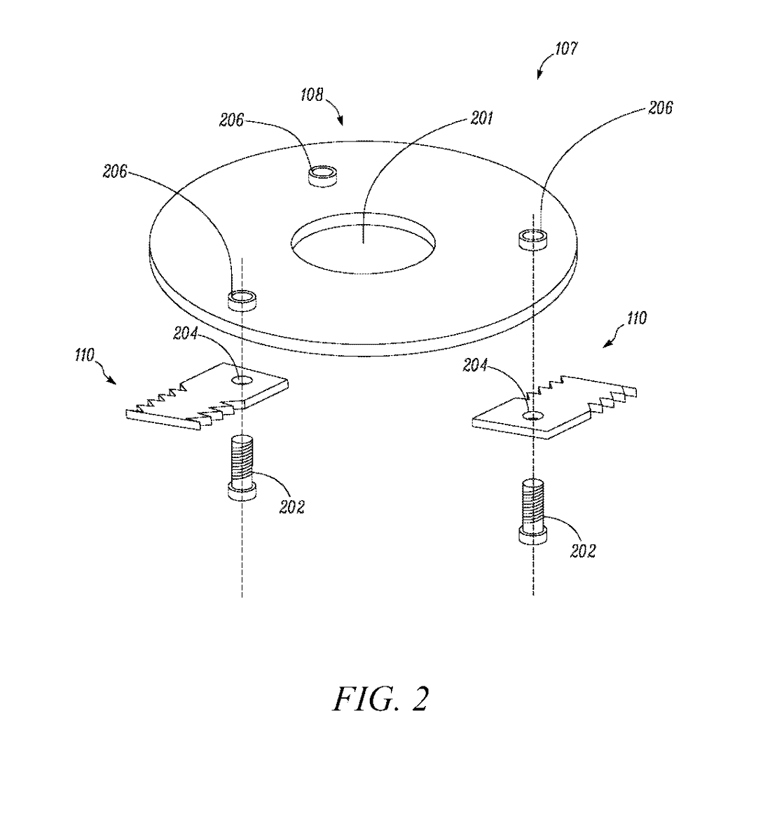

FIG. 2 illustrates the cutting unit 107, according to an embodiment of the present invention. Only two cutting blades 110 are illustrated for clarity. As illustrated in FIG. 2, the blade holder 108 includes a coupling aperture 201 for connection with the output shaft of the prime mover or the transmission assembly. Further, the cutting blade 110 is detachably connected to the blade holder 108 via at least one fastening member 202. The fastening member 202 may be a threaded bolt. The fastening member 202 is inserted into an aperture 204 of the cutting blade. Moreover, the blade holder 108 includes receiving members 206 configured to accept the corresponding fastening member 202. Each receiving member 206 may include internal threads which couple with the threads of the fastening member 202. The configuration of the cutting unit 107, as illustrated in FIG. 2, is purely exemplary in nature and alternate configurations are possible without deviating from the scope of the present invention. For example, the cutting blade 110 may be attached to the blade holder 108 via multiple fastening members. The cutting blade 110 may be attached to the blade holder 108 via a nut and a bolt assembly (not shown). Alternately, the cutting blade 100 may be attached to the blade holder 108 via a quick coupling. The cutting blade 110 may also be connected to the blade holder 108 by any other means, for example, welding, brazing, adhesives, or the like. Alternatively, the cutting blades 110 and the blade holder 108 may be fabricated as a unitary structure.

In various embodiments, cutting blade 110 may also be pivotally connected to the blade holder 108. In such a case, the cutting blade 110 may be normally biased by at least one resilient member (E.g., a spring) in a retracted position. However, when the blade holder 108 rotates above a pre-determined speed, a centrifugal force may overcome the biasing force of the resilient member and the cutting blade 110 pivots to a cutting position. Further, if the cutting blade 110 encounters any obstruction (E.g., a wall, a tree, a rock, or the like) the cutting blade 110 automatically pivots to the retracted position. This may substantially reduce damage to the cutting blade 110. Moreover, overloading of the transmission assembly and/or the prime mover may also be prevented.

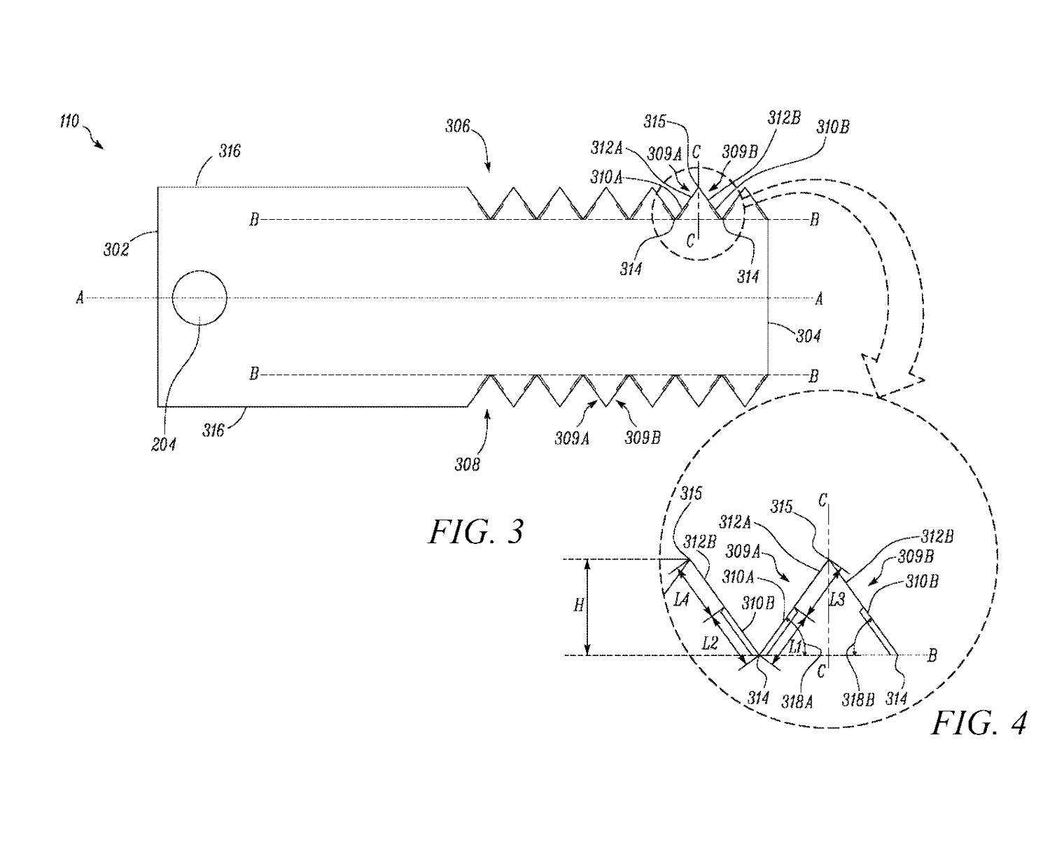

FIGS. 3 and 4 illustrate the cutting blade 110, according to an embodiment of the present invention. In various embodiments, the cutting blade 110 may be made of a metal, a composite, plastic or the like. The cutting blade 110 includes a first end section 302, a second end section 304, and two lateral sections 306 and 308 extending between the first end section 302 and the second end section 304. The aperture 204 is located proximate the first end section 302. The cutting blade 110 is symmetric about a longitudinal axis A. However, the cutting blade 110 may also be asymmetric (described in conjunction with FIG. 6).

Further, each of the lateral sections 306, 308 include multiple first and second inclined edges 309A, 309B arranged alternatively. Further, each of the first and second inclined edges 309A and 309B extends from a proximal end 314 on a base line B which is parallel to the longitudinal axis A of the cutting blade 110. Moreover, each of the first and second included edges 309A and 309B intersect each other at a distal end 315. Each first inclined edge 309A includes a cutting portion 310A and a protective portion 312A arranged adjacent to one another. The cutting portion 310A is adjacent to the base line B and originates from the proximal end 314. The protective portion 312A is adjacent to and ends at the distal end 315. Similarly, each second inclined edge 309B includes a cutting portion 310B and a protective portion 312B arranged adjacent to one another. The cutting portion 310B is adjacent to the base line B and originates from the proximal end 314. The protective portion 312B is adjacent to and ends at the distal end 315. Intermediate portions 316 connect the first end section 302 to the nearest proximal ends 314 on the respective lateral sections 306, 308. Each first inclined edge 309A is inclined at a first angle 318A relative to the longitudinal axis A (the first angle 318A is shown between the first inclined edge 309A and the base line B which is parallel to the longitudinal axis A) of the cutting blade 110. Further, each second inclined edge 309B is inclined at a second angle 318B relative to the longitudinal axis A (the second angle 318B is shown between the second inclined edge 309B and the base line B) of the cutting blade 110. In an embodiment, the first angle 318A and the second angle 318B are substantially equal such that each of the first and second inclined edges 309A and 309B form a symmetric triangular structure about a central axis C. In an embodiment, the first angle 318A and the second angle 318B lie in a range from about 10 degrees to 60 degrees. In an alternate embodiment, the first angle 318A and the second angle 318B may not be equal, and each of the first and second inclined edges 309A and 309B form a non-symmetric structure about the central axis C. In an embodiment, a height H of the distal end 315 from the base line B lies in a range from about 0.5 mm to 10 mm. The first and second inclined edges 309A and 309B are embodied as straight edges. However, in various other embodiments, each of the first inclined edges 309A and/or the second inclined edges 309B may be curvilinear, or polygonal. In such cases, the first and second angles 318A, 318B may be the angles between the tangents of the first and/or second inclined edges 309A, 309B, respectively, at their proximal ends 314 and the longitudinal axis A. The first angle 318A and the second angle 318B may also change for different first and second inclined edges 309A, 309B.

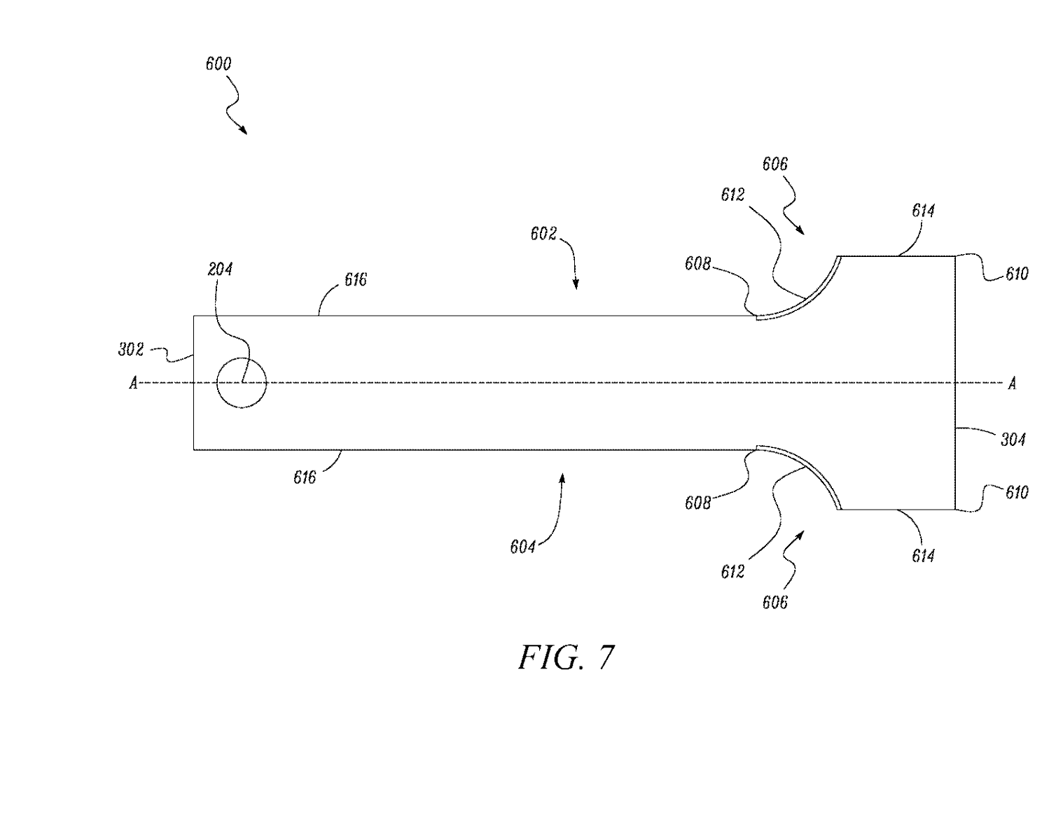

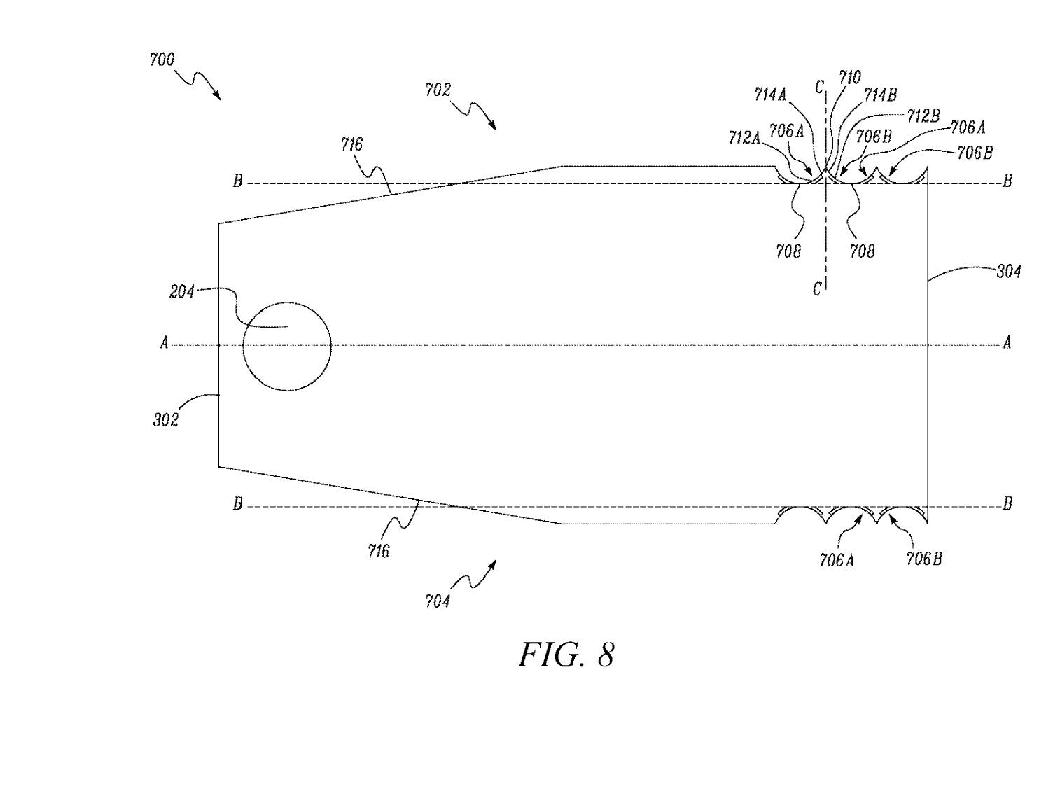

The cutting portions 310A and 310B are configured to cut vegetation, such as, grass. The cutting portions 310A and 310B are therefore sharpened edges. The cutting portions 310A and 310B are embodied as straight edges. However, the cutting portions 310A and 310B may be curvilinear (shown in FIGS. 7 and 8) or polygonal in shape within the scope of the present invention. In an embodiment, lengths L1 and L2 of each of the cutting portions 310A and 310B, respectively, lie in a range from about 0.5 mm to 20 mm depending on H. The lengths L1 and L2 may be substantially equal.

As illustrated in FIGS. 3 and 4, each of the protective portions 312A and 312B are embodied as straight edges. Thus, the protective portions 312A and 312B form a triangular region around the distal end 315. However, each of the protective portions 312A and 312B may be curvilinear (shown in FIG. 8) or polygonal in shape within the scope of the present invention. Each protective portion 312A or 312B is configured to protect the adjacent cutting portion 310A or 310B. In an embodiment, lengths L3 and L4 of the protective portion 312A and 312B, respectively, lie in a range from about 0 mm to 10 mm. The lengths L3 and L4 may be substantially equal. During a cutting portion, the cutting blade 110 may strike against objects other than vegetation, such as, sticks, stones, toys etc. In such case, only the protective portions 312A and 312B contact the objects and safeguard the cutting portions 310A and 310B, respectively. Thus, the cutting portions 310A and 310B may continue to cut vegetation normally without getting blunt by repeated contacts against objects. Therefore, an operating life of the cutting blade 110 is substantially increased. Thus, periods between replacements of the cutting blades 110 are also increased. In an embodiment, the lateral sections 306 and 308 are alternately used for cutting vegetation by changing the rotational direction of the blade holder 108 periodically. This further increases an operating life of the cutting blade 110.

In an embodiment of the present invention, the protective portions 312A and 312B may be manufactured as sharpened edges along with the cutting portions 310A and 310B. However, during operation, only the protective portions 312A and 312B may strike against objects and become blunt, thereby protecting the cutting portions 310A and 310B.

The cutting blade 110, as illustrated in FIGS. 3 and 4, is exemplary in nature, and the cutting blade 110 may be of any alternate configuration within the scope of the present invention. For example, the base lines B of the lateral sections 306, 308 may be curvilinear (For example, concave or convex) or polygonal in shape. Alternatively, the base lines B may be tapered inwards or outwards relative to the longitudinal axis A. Further, the first and/or second end sections 302, 304 may also be curvilinear or polygonal. Moreover, another set of intermediate sections may be provided between the second end section 304 and the nearest first or second inclined edges 309A, 309B. In various alternate embodiments, the cutting portions 310A and 310B may not originate directly from the proximal ends 314 but start at a distance from the proximal ends 314.

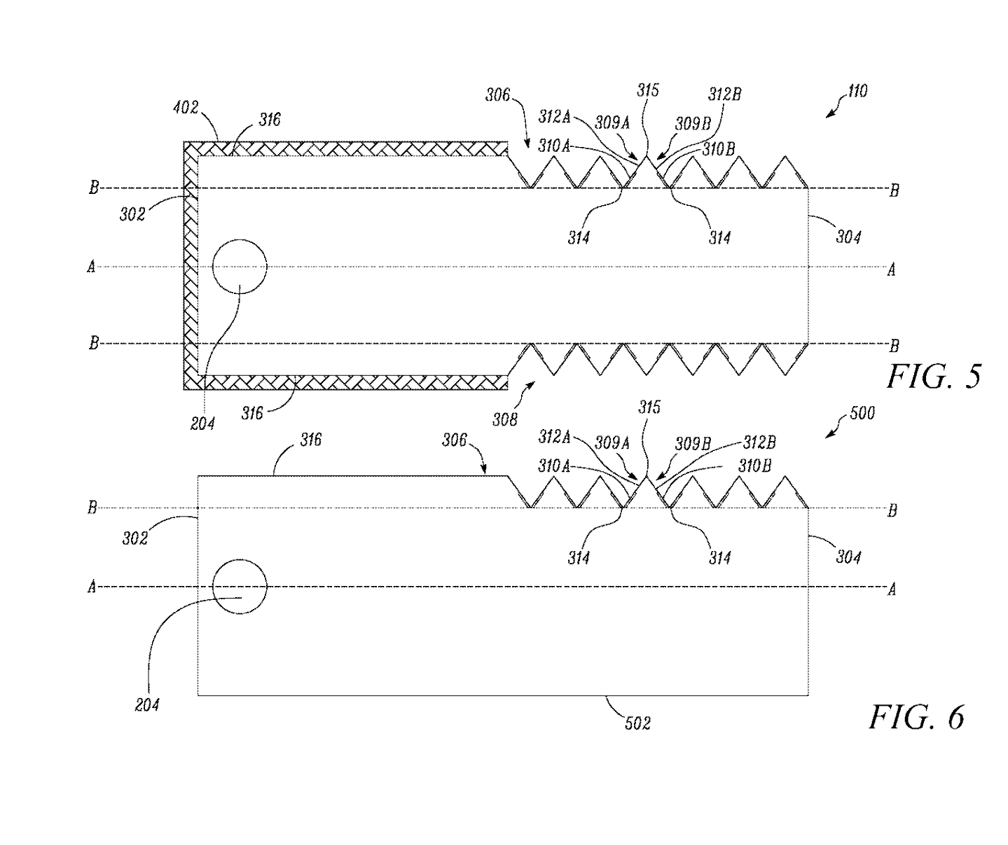

FIG. 5 illustrates the cutting blade 110 with a gripping member 402 enclosing the first end section 302 and the intermediate portions 315 of the lateral sections 306, 308. In an embodiment, the gripping member 402 may be made of rubber. The gripping member 402 may facilitate manual gripping of the cutting blade 110. The gripping member 402 may also protect a user from the cutting portions 310A, 310B during manual handling of the cutting blade 110.

FIG. 6 illustrates the cutting blade 500, according to another embodiment of the present invention. As illustrated in FIG. 5, only the lateral section 306 includes the first and second inclined edges 309A and 309B, whereas a lateral section 502 is embodied as a straight edge. Therefore, the cutting blade 500 is asymmetric about the longitudinal axis A. In various embodiments, the lateral section 502 may include a sharpened portion configured to cut vegetation. The lateral section 502 may also be curvilinear, tapered, or polygonal within the scope of the present invention.

FIG. 7 illustrates a cutting blade 600, according to yet another embodiment of the present invention. As illustrated in FIG. 7, each of lateral sections 602 and 604 includes a single inclined edge 606. The inclined edge 606 extends from a proximal end 608 and intersects the second end section 304 at a distal end 610. Further, the inclined edge 606 includes a cutting portion 612 and a protective portion 614 adjacent to the cutting portion 612. The cutting portion 612 originates from the proximal end 608, while the protective portion 614 terminates at the distal end 610. Further, intermediate portions 616 are substantially parallel to the longitudinal axis A. In alternate configurations, the intermediate portions 616 may be also inclined to the longitudinal axis A.

As illustrated in FIG. 7, the cutting portion 612 is inclined relative to the longitudinal axis A of the cutting blade 600. Further, the cutting portion 612 is curvilinear. In various embodiments, the cutting portion 612 may be substantially circular, elliptical, parabolic, hyperbolic or the like. Further, the protective portion 614 is straight and substantially parallel to the longitudinal axis A.

FIG. 8 illustrates a cutting blade 700, according to an embodiment of the present invention. As illustrated in FIG. 8, the cutting blade 700 includes two lateral sections 702 and 704 extending between the first end section 302 and the second end section 304. Each of the lateral sections 702, 704 include multiple first and second inclined edges 706A, 706B arranged alternatively. Further, each of the first and second inclined edges 706A and 706B extends from a proximal end 708 on the base line B which is parallel to the longitudinal axis A of the cutting blade 700. Moreover, each of the first and second included edges 706A and 706B intersect each other at a distal end 710. Further, each of the first and second inclined edges 706A, 706B is curvilinear. In various embodiments, each of the first and second inclined edges 706A, 706B may be substantially circular, elliptical, parabolic, hyperbolic or the like. In an embodiment, the first and second inclined edges 706A, 706B may form a symmetric structure about the central axis C.

As illustrated in FIG. 8, each first inclined edge 706A includes a cutting portion 712A and a protective portion 714A arranged adjacent to one another. The cutting portion 712A is adjacent to the base line B and originates from the proximal end 708. The protective portion 714A is adjacent to and ends at the distal end 710. Similarly, each second inclined edge 706B includes a cutting portion 712B and a protective portion 714B arranged adjacent to one another. The cutting portion 712B is adjacent to the base line B and originates from the proximal end 708. The protective portion 714B is adjacent to and ends at the distal end 710. Intermediate portions 716 connect the first end section 302 to the nearest proximal ends 708 on the respective lateral sections 702, 704. Each of the intermediate portions 716 is inclined to the longitudinal axis A. However, in alternate embodiments, the intermediate portions 716 may be substantially parallel to the longitudinal axis A.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A cutting blade of a robotic mower,
the cutting blade comprising:
a first end section and a second end section, and
two lateral sections extending between the first and second end sections,
wherein at least one of the two lateral sections comprises at least one cutting portion configured to cut vegetation and at least one protective portion configured to protect the at least one cutting portion.

2. The cutting blade according to claim 1, wherein the at least one protective portion is configured to cut vegetation and configured to strike against objects other than vegetation to protect the at least one cutting portion.

3. The cutting blade according to claim 1, wherein the at least one lateral section comprises at least one inclined edge, wherein at least a portion of the at least one inclined edge is inclined relative to a longitudinal axis of the cutting blade, and wherein the at least one inclined edge comprises the at least one cutting portion and the at least one protective portion.

4. The cutting blade according to claim 3, wherein the at least one cutting portion is located adjacent a proximate end of the at least one inclined edge, and the at least one protective portion is located adjacent a distal end of the at least one inclined edge.

5. The cutting blade according to claim 4, wherein the at least one lateral section comprises at least one first inclined edge and at least one second inclined edge connected to each other at their distal ends.

6. The cutting blade according to claim 5, wherein the at least one lateral section comprises multiple first inclined edges and second inclined edges arranged alternatively.

7. The cutting blade according to claim 3, wherein the at least one lateral section further comprises an intermediate portion connecting the at least one inclined edge to the first end section.

8. The cutting blade according to claim 7, wherein the intermediate portion is inclined relative to the longitudinal axis of the cutting blade.

9. The cutting blade according to claim 1, wherein the at least one inclined edge is straight, curvilinear, or polygonal.

10. The cutting blade according to claim 1, wherein both the lateral sections comprise the at least one cutting portion and the at least one protective portion.

11. The cutting blade according to claim 3, wherein the cutting blade is symmetric about the longitudinal axis.

12. The cutting blade according to claim 3, wherein the cutting blade is asymmetric about the longitudinal axis.

13. The cutting blade according to claim 1, the preceding further comprises a gripping member enclosing at least partly the two lateral sections.

14. The cutting blade according to claim 13, wherein the gripping member is made of rubber.

15. The cutting blade according to claim 1, wherein the cutting blade is detachably attached to a blade holder of the robotic mower proximate the first end section, the blade holder being configured to be rotatably driven.

16. A cutting blade according to claim 15, wherein the cutting blade further comprises an aperture proximate the first end section, the cutting blade being detachably attached to the blade holder via a fastening member passing through the aperture.
